(19) United States
(12) Patent Application Publication
(10) Pub. No.: US 2025/0356036 A1
(43) Pub. Date: Nov. 20, 2025

(54) TECHNOLOGIES FOR ACCESSING SECURE ASSETS OF CHIPLETS

(71) Applicant: Intel Corporation, Santa Clara, CA (US)

(72) Inventors: Kapil SOOD, Washougal, WA (US); Anjali SOOD, Washougal, WA (US)

(21) Appl. No.: 19/290,211

(22) Filed: Aug. 4, 2025

(51) Int. Cl. G06F 21/62

(52) U.S. Cl. CPC G06F 21/62

(57) ABSTRACT

Examples described herein relate to a chiplet comprising a circuitry to store a security policy, specific to the chiplet, and a second chiplet comprising a second circuitry to store a second security policy, specific to the second chiplet. In some examples, at least two of the multiple chiplets are from different chiplet manufacturers.

### BACKGROUND

A System-In-Package (SiP) encompasses multiple chiplets within a single package. Chiplet debug operations identify and resolve defects or malfunctions of chiplets for ensuring the reliability, performance, and successful integration of chiplets.

FIG. 1 depicts a prior art example of single vendor multi-chiplet SiP debug architecture. System 100 includes chiplets developed, debugged, packaged, fabricated, validated, and productized by a single vendor. The chiplets of the SiP follow uniform, vendor-specific security debug policy and secure design for x (e.g., manufacturing, test, debug, validation) (Dfx). For example, an SiP with chiplets from a single vendor has a common set of Intellectual Property (IP), Security Assets Classification, Dfx security keys, unlock behavior, debug policy, etc. At (1), a primary root of trust for debug (RoTD) chiplet (e.g., input/output (IO) and memory chiplet 1) accesses a common debug security policy and at (2) the primary RoTD distributes the debug security policy to secondary chiplet RoTDs. Thereafter, a debug operation can take place for the chiplets in the SiP.

### BRIEF DESCRIPTION OF THE DRAWINGS

FIG. 1 depicts a prior art example debug architecture.

FIG. 2 depicts an example multi-vendor chiplet architecture.

FIG. 3 depicts an example system.

FIG. 4 depicts an example of provisioning security policy credentials for multi-vendor chiplets.

FIG. 5 depicts an example of a chiplet vendor security credential distribution flow.

FIG. 6 depicts an example of a SiP vendor security credential distribution flow.

FIG. 7 depicts an example of calibration of debug policies of different chiplet manufacturers.

FIG. 8 depicts an example of remote orchestration control of debug policies of multiple chiplet vendors.

FIGS. 9A and 9B depict example processes.

FIG. 10 depicts an example system.

### DETAILED DESCRIPTION

Cloud service providers (CSPs) and customers deploy varying applications across cloud, edge, client, and Internet of things (IoT). Customers can utilize custom SiPs dedicated to specific artificial intelligence (AI) models and inferencing needs (e.g., Retrieval-augmented generation (RAG), large language models (LLMs), vision analytics, federated learning, and others) and scale of the models (e.g., ChatGPT, Claude, DeepSeek, etc.). Custom SiPs can utilize custom chiplets from multiple vendors and chiplets from different vendors can be built on separate processes and foundries. Accordingly, an SiP can include chiplets from different vendors. For example, SiP systems can include cores from the preferred software workloads (e.g., Intel® Architecture, ARM, or others) and memory and input output (IO) developed by specific vendors targeting various SiP system requirements (e.g., memory types, Compute Express Link (CXL) support, Peripheral Component Interconnect Express (PCIe) lanes, cache sizes, on-chiplet High Bandwidth Memory (HBM), latency key performance indicators (KPIs), etc.).

A system includes security assets such as cryptographic keys, configuration data, intellectual property, and sensitive user data, that are stored in registers, memory blocks, fuses and/or otherwise embedded in the silicon. When a debugger places an SiP in a debug mode, access privileges become available. For example, during debug, debug registers expose read-write access to internal states of a system that are not visible in a production mode. Assets from chiplets of different chiplet vendors might be compromised due to the privileged access these debug capabilities may provide.

Various examples can provide technologies for chiplets from different vendors to protect their security assets such as cryptographic keys, configuration data, intellectual property, and sensitive user data during debug, validation, and productization of a chiplet or through the domain of the SiP vendor, Multi-Chiplet Package (MCP) vendor, Original Equipment Manufacturer (OEM)/Original Design Manufacturer (ODM) domain, and while at the end-customer. Various examples provide technologies to securely debug the chiplets from multiple different vendors and maintain secrecy of security assets, IP secrets, configuration policies, and other configurations or data stored on a chiplet. A leader chiplet can determine debug policies of other chiplets and determine a debug policy to apply to the chiplets. Alignment of debug policies from different chiplet vendors can occur. A chiplet can communicate with other chiplets to apply a highest common level of debug policy among the aligned debug policies. Various examples provide a secure, federated debug and Dfx security architecture for a SiP that includes chiplets developed and fabricated by different vendors, and packaged by the same or different vendor to allows customers and vendors to securely build SiP and control and explicitly authorize sharing of secrets in chiplets. Various examples of chiplets include integrated circuits (ICs), processors, memory, input/output (I/O) devices, accelerators, or other circuitries.

Various examples of the multi-vendor and multiple chiplet SiP perform key management and security policy/credentials provisioning for security enforcement, vendor-chosen policy application at stages of chiplet productization, and explicit authorization and verification of policies by the chiplet and SiP vendors.

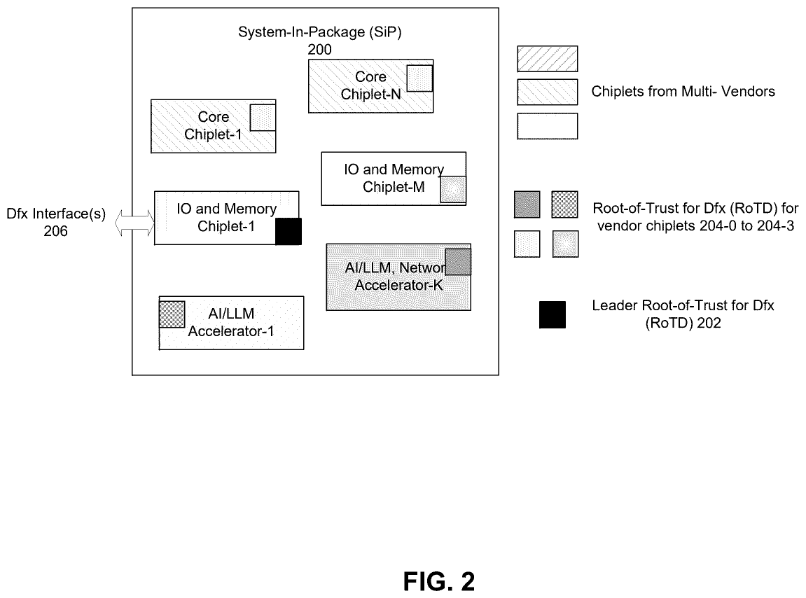

FIG. 2 depicts an example multi-vendor chiplet SiP RoT for debug (RoTD) architecture. To prevent secret leakage, an RoTD 202 of a chiplet (e.g., IO and memory chiplet-1) can be configured to perform operations of a leader RoTD. An RoTD can include one or more of: a microprocessor that executes instructions, firmware, application specific integrated circuit (ASIC), field programmable gate array (FPGA), or other circuitry. In some examples, one or more ROTDs can be consistent with Open Compute Project (OCP), “Caliptra: A Datacenter System on a Chip (SoC) Root of Trust (RoT)” Revision 1.0, Version 0.5 (July 2022), and variations thereof.

Leader RoTD 202 can engage in a security policy sharing with RoTD 204-0 to 204-3 of other chiplets within SiP 200 so that chiplets in SiP 200 share debug policies and can apply a common level of access to secrets during debug at the same privilege or policy level. Secrets can include one or more of: hardware secrets, hardware keys, or a hash of a key. Provisioning of base security credentials and policy and authorization mappings in chiplets and SiP 202 can restrict access to chiplet assets to a level of access shared to the chiplets. Various examples of calibrating levels of secret data access are described herein.

One or more debug (Dfx) port 206 can be used to access multi-chiplet, multi-vendor SiP 200. In some examples, different chiplet vendors may utilize isolated debug ports for the chiplets from the chiplet vendor. Via debug port 206, chiplet vendors can independently verify credentials and access levels of data of a chiplet. The chiplet and SiP can provide a trusted signed attestation quote indicating credentials and access levels of data of a chiplet to a chiplet vendor.

Different chiplet vendor SiPs have different data access authorization policies. For example, chiplets from different chiplet vendors (e.g., Intel, Amazon Web Services (AWS), and Nvidia) apply vendor specific debug policies, security assets classification, Dfx security keys, unlock behavior, etc. To provide a common data access policy for chiplets from different chiplet vendors, vendors can map their own individual policies to a common set of policies. For example, chiplet manufacturer A's “M” debug unlock can map to chiplet vendor B's “X” debug unlock. Chiplet vendors can apply a common baseline of asset sharing or modification for debug policy and make specific security assets visible or updatable for the policy levels or protection class.

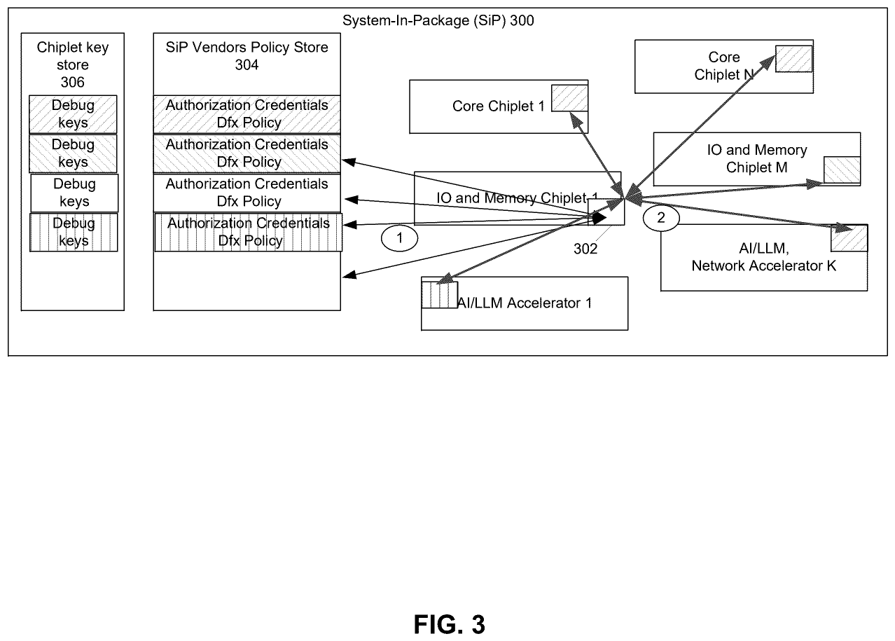

FIG. 3 depicts an example system. In SiP 300, leader RoTD 302 of a chiplet (e.g., IO and memory chiplet 1 or other) can drive a federated debug security policy, with other chiplets (e.g., core chiplet 1 to N, IO and memory chiplet 2 to IO and memory chiplet M, and AI/LLM accelerator 1 to K, where N, M, and K are integers).

An example operation is as follows. At (1), leader RoTD 302 can perform mutual authentication with RoTD of other chiplets based on authentication keys provisioned during chiplet manufacture. Leader RoTD 302 can perform mutual authentication with RoTD of other chiplets based on the keys shared by the other RoTD with the leader RoTD matching expected key values. Leader RoTD 302 can be manufactured by SiP vendor or not by the SiP vendor.

At (2), based on mutual authentication between leader RoTD 302 and RoTD of other chiplets, leader RoTD 302 can read Dfx policies from different chiplets and store Dfx policies into SiP NVM 304. Subsequently, a debugger can perform debug based on a debug policy level common to the chiplets.

For a debug policy, protection classes can define debug capabilities that are available for a specific chiplet. The debugger can provide a digital signature or key that is verified before the debugger is granted access to a privileged set of debug capabilities based on its identity via authentication. Blocking of debug capabilities can protect assets stored on the SiP and chiplets.

The available debug capabilities can change as the class increases. For example, a first protection class has the least number of debug capabilities available with no protection mechanisms on those debug capabilities. For example, the first protection class can permit debuggers with a least amount of access to data, such as private and/or secure assets. Examples of the first protection class capabilities may include Institute of Electrical and Electronics Engineers (IEEE) Boundary Scan, basic telemetry, software debugging capabilities provided by the OS, and Crash Log.

For example, a second protection class permits an authorized debugger to access additional debug capabilities beyond the first protection class and access private and/or secure assets. For example, a particular authentication key may permit utilization of the second protection class.

For example, a third protection class permits a debugger to access additional debug capabilities beyond the second protection class and access private and/or secure assets. For example, a particular authentication key may permit utilization of the third protection class.

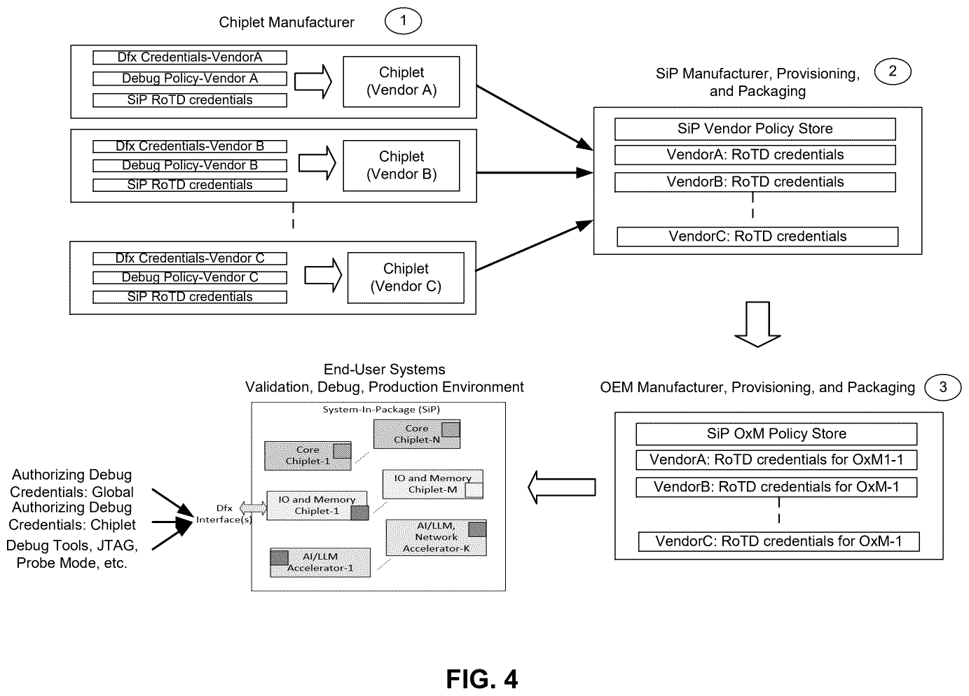

FIG. 4 depicts an example of provisioning security policy credentials for multi-vendor chiplets. At (1), in chiplet semiconductor fabrication plants, based on SiP vendor authorization keys and debug policies, different chiplet vendors and fabricators can provision secured assets (e.g., RoTD keys, debug keys, debug policies, etc.). In addition, based on SiP vendor authorization keys and debug policies, different chiplet vendors can provision secure credentials, including public key components of Digital Signing Algorithm (DSA) that the chiplet vendors chose (e.g., PQC ML-DSA, PQC, ML-SLH, RSA/EC, Hybrid, . . . ). Credentials can be provisioned in chiplet immutable storage (e.g., immutable fuses, in-field One-Time Programmable (OTP) fuses, on-chiplet Non-Volatile Random-Access Memory (NVRAM), etc.).

At (2), after generating security credentials, a chiplet vendor can deliver its public key equivalents of its security credentials to the SiP vendor. The SiP vendor can be trusted to install the correct chiplet credentials (e.g., debug keys) in non-volatile memory (e.g., chiplet key store 306 of FIG. 3). If the SiP vendor does not install the correct chiplet credentials, the SiP chiplets' RoTD will not be unlocked and cannot communicate to determine a debug policy to apply. Therefore, authorization control remains with the chiplet vendor for their own chiplets. Subsequently, the SiP vendor manufactures an SiP with chiplets from different vendors.

At (3), an OEM or ODM can provision the chiplet and SiP vendors security credentials in non-volatile memory during manufacturing stages of a system that integrates SiP from multiple different vendors.

In a debug cycle of the SiP, a debugger injects an appropriate security credential into the SiP with the chiplets from different vendors. Based on receipt of approved debug credentials, a chiplet can provide event logs, execution traces, and/or event sequences. Logs can include data related to the activity of various hardware components within the chiplet, performance data about the system's performance such as including bottleneck detection, software/firmware trace and debug data such as diagnostic information from the software and firmware running on the system. Execution traces can include record of instructions executed including control flow and transactions (even aborted ones) to help identify issues not readily apparent from the call stack alone. Event sequences can include information about the order and timing of system events. For debug performed for key management hardware, traces can show a secure cryptographic hash of the secret(s).

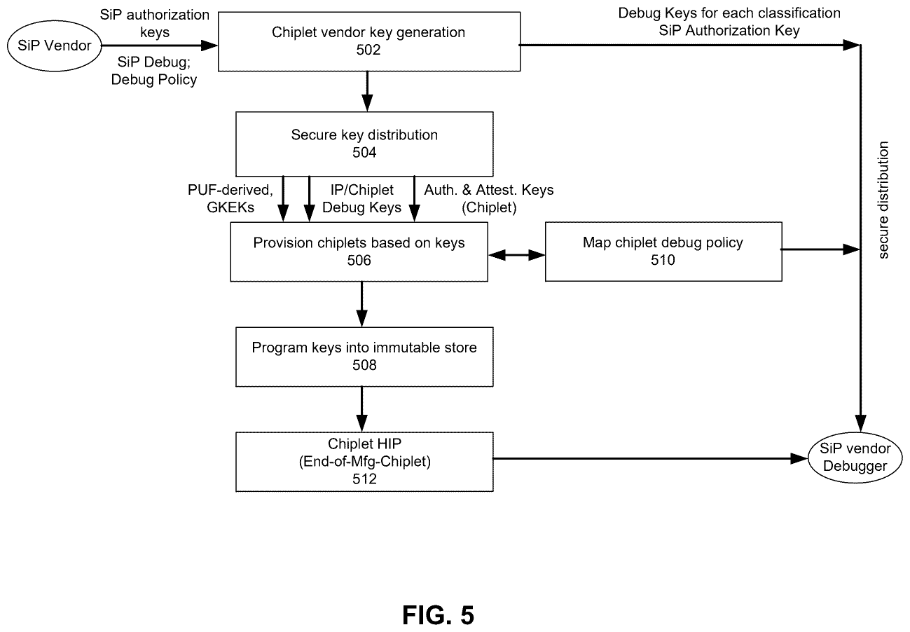

FIG. 5 depicts an example of a chiplet vendor security credential distribution flow. Based on RoTD keys and debug policies from an SiP vendor, at 502, a chiplet vendor can generate cryptographic keys for RoTD of chiplets. Keys can include at least one or more of: Physical Unclonable Function (PUF)-derived Group Key Encryption Keys (GKEKs), chiplet RoTD debug authorization keys, chiplet debug keys, or others. PUF-derived GKEKs can be unique, unclonable keys from a chip's inherent physical variations (e.g., integrated circuit characteristics). PUF-generated keys can be used as a Key Encryption Key (KEK) to encrypt other user-defined keys. SiP authorization key can include chiplet RoTD credential keys for chiplet RoTDs to authenticate other chiplet RoTDs and to determine a debug policy to apply. Chiplet RoTD debug authorization keys can be utilized by a leader RoTD and RoTD of other chiplets to determine whether an RoTD is permitted to share its chiplet debug policy with a leader RoTD and for the leader RoTD to select a debug policy for the chiplet to apply. A chiplet debug key can be used to authenticate a debugger to determine whether the debugger is permitted to perform a debug operation on a chiplet. For example, a chiplet vendor's Hardware Security Module (HSM) can store and manage cryptographic keys.

At 504, secure key distribution to chiplets of keys to chiplets can occur. At 506, provisioning of cryptographic keys to chiplets can occur during manufacture of chiplets. At 508, chiplet manufacturer can program the keys and secure assets into immutable storage of the chiplet.

At 510, security assets classification of chiplet can map debug policy of the chiplet to a level of a debug policy of multiple chiplets. Different chiplet manufacturers may utilize different debug policies. Policy mappings can be agreed upon by SiP and chiplet vendors. Such a mapping may be prescribed by a single vendor and followed by vendors or be part of an industry-wide debug standard for multi-chiplets, or jointly agreed upon. Chiplets, from different vendors, are to attain a common baseline policy level that makes specific security assets visible (or, updatable) at that common policy level. As described herein, a leader RoTD of a chiplet can select a debug security policy for chiplets and distribute specific policies to each vendors' chiplet RoTDs. Mapped chiplet debug classification can specify a policy level of a common debug policy mapped to debug policies of different chiplet vendors.

At 512, the chiplet hard IP (HIP) with configured RoTD and stored secure keys is manufactured and available for distribution to a SiP vendor. Thereafter, SiP vendor can be provided with one or more of: classification SIP authorization key or mapped chiplet debug classification.

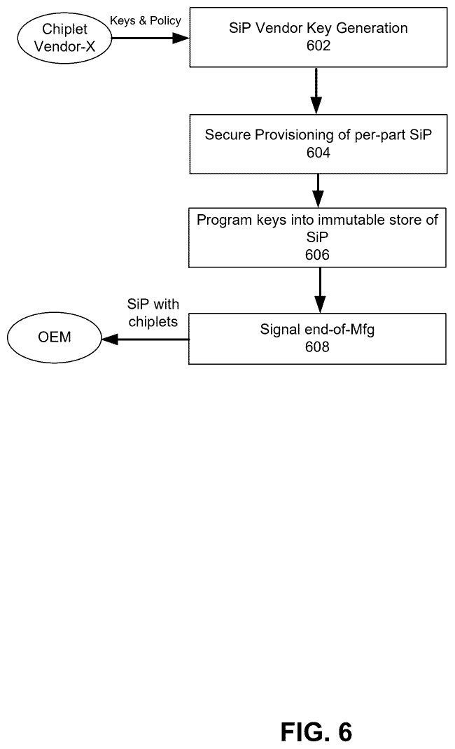

FIG. 6 depicts an example of a SiP vendor security credential distribution flow. At 602, during SiP manufacturing, based on receipt of keys and debug policies from chiplet vendors, SiP vendor can perform secure provisioning of the security assets and debug policies of chiplet vendor's chiplet(s). For example, the keys can include debug keys that can be used by a debugger to access secure data during application of a particular debug policy. For example, debug authorization key X for debug policy 1 and debug authorization key Y for debug policy 2.

At 604, SiP vendor can provision chiplet vendor debug keys in SiP vendor's HSM key generator. At 606, SiP vendor can store the chiplet debug keys into immutable storage of SiP. Immutable storage can include silicon fuses, secure storage, one time programmable memory, or others. At 608, end of SiP manufacturing can be signaled based on formation of an SiP with chiplets. The SiP with chiplets can be provided to an OEM or ODM. The OEM or ODM can integrate the SiP with other SiPs or devices from other vendors. While references are made to SiP vendors, other multi-chip integrators can utilize technologies described such as multi-chip platform (MCP). References to SiP can apply also, or alternatively, to MCP.

While examples are described with respect to debugging chiplets, other examples can apply to authentication or attestation of chiplets or an SiP with an OEM system. For example, authentication can include determination of legitimacy and integrity of individual chiplets within a multi-chiplet system such as an SiP or SiPs with an OEM system. Chiplet attestation can include verifying the authenticity, integrity, and trustworthiness of individual chiplets or SiPs with an OEM system.

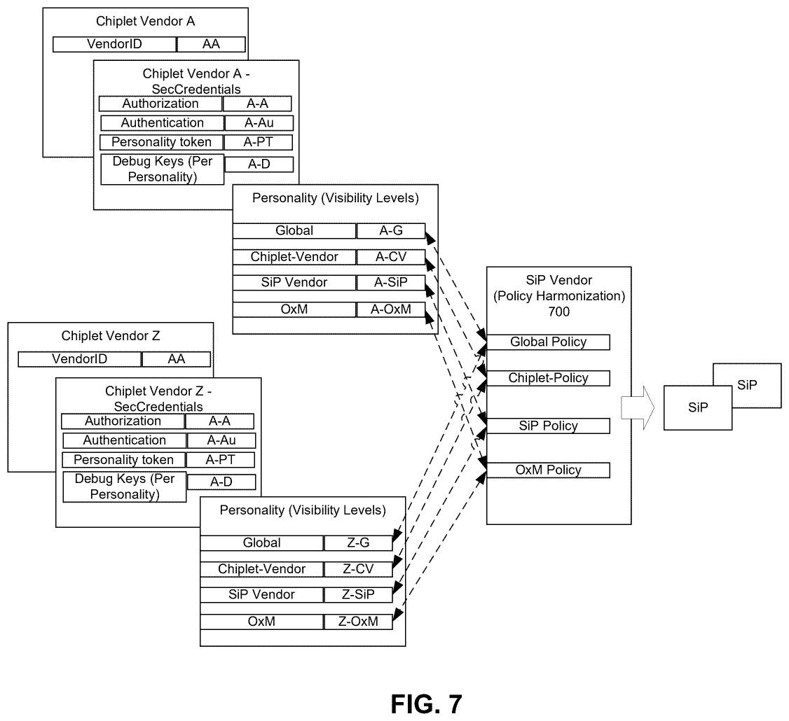

FIG. 7 depicts an example of calibration of debug policies of different chiplet manufacturers. For example, based on chiplets from multiple different vendors having different debug policies, SiP vendor policy harmonization 700 can determine debug visibility policies that apply to multiple chiplets in an SiP, multiple SiPs in a system formed by an OEM or ODM, or multiple integrated OEM or ODM systems. For example, debug visibility policies of different vendors can be mapped to one or more protection levels. For example, if a debug visibility policy of vendor A permits access to event logs and execution traces but a debug visibility policy of vendor B permits access to event logs, execution traces, and event sequences, a first protection level can be mapped to permit merely access to event logs and execution traces but not event sequences. For example, if a debug visibility policy of vendor A permits access to PUF-derived GKEKs, and chiplet authorization and attestation keys but a debug visibility policy of vendor B permits access to chiplet authorization and attestation keys, a second protection level can be mapped to permit merely access to chiplet authorization and attestation keys but not PUF-derived GKEKs. For example, a global debug visibility policy of all access can permit access to secure assets of multiple chiplets in an SiP, multiple SiPs in a system formed by an OEM or ODM, or multiple integrated OEM or ODM systems.

Various debug visibility policies can be applied per-chiplet, per-SiP, and per-OxM system.

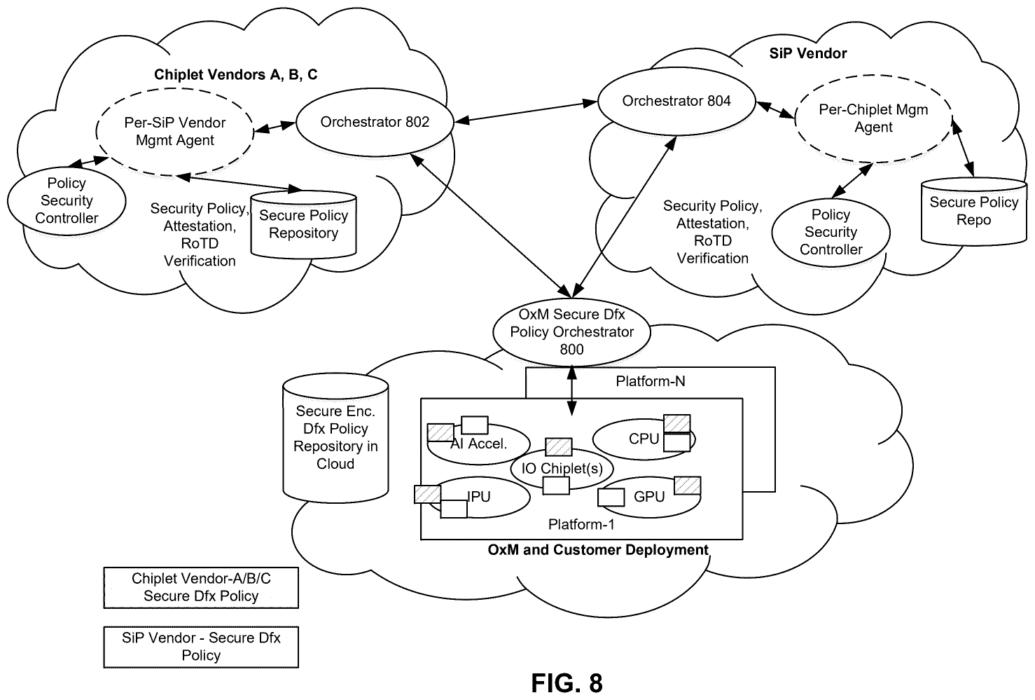

FIG. 8 depicts an example of remote orchestration control of debug policies of multiple chiplets from different vendors. To address real-time authorization and/or visibility to a vendor during different stages of debug or Dfx by a user (e.g., chiplet vendor, SiP, OEM/ODM, end customer, or others), a chiplet vendor can perform remote attestation of a debug scheme of chips. For example, orchestrator 800 can communicate with orchestrator 802 to configure chiplet vendors' debug keys and debug policies for various chiplet devices including accelerators (Accel.), IO chiplets, CPUs, GPUs, IPUs (e.g., infrastructure processing units), or others. For example, orchestrator 800 can communicate with orchestrator 804 to configure SiP vendors' debug keys and debug policies. Various attestation protocols and message constructs can be used including Intel Security Libraries for Datacenter (SecL-D), Intel CPU Attestation, DMTF's Security Protocols and Data Models (SPDM), Internet Engineering Task Force (IETF) attestation protocols, or others.

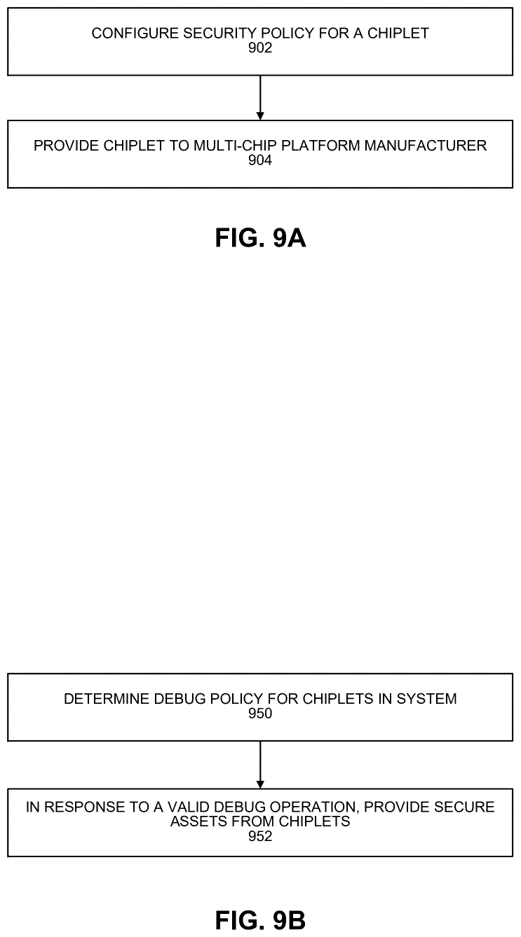

FIG. 9A depicts an example process to configure a chiplet to set debug policies for different chiplets in an SiP. At 902, a security policy can be configured for the chiplet. For example, the security policy can include one or more of: a debug policy, a debug key, or a RoTD authentication key. At 904, the chiplet can be made available for integration into a SiP or multi-chiplet platform.

FIG. 9B depicts an example process. The process can be performed by a chiplet during manufacture of an SiP or in response to a debug operation request. At 950, a leader RoTD of a chiplet can negotiate debug policy with RoTDs of other chiplets. The leader RoTD can determine a highest common debug policy for the chiplets to apply and cause the chiplets to apply the determined debug policy. At 952, based on receipt of a debug request and authentication of a debugger, one or more chiplets can share secure data in accordance with the determined debug policy.

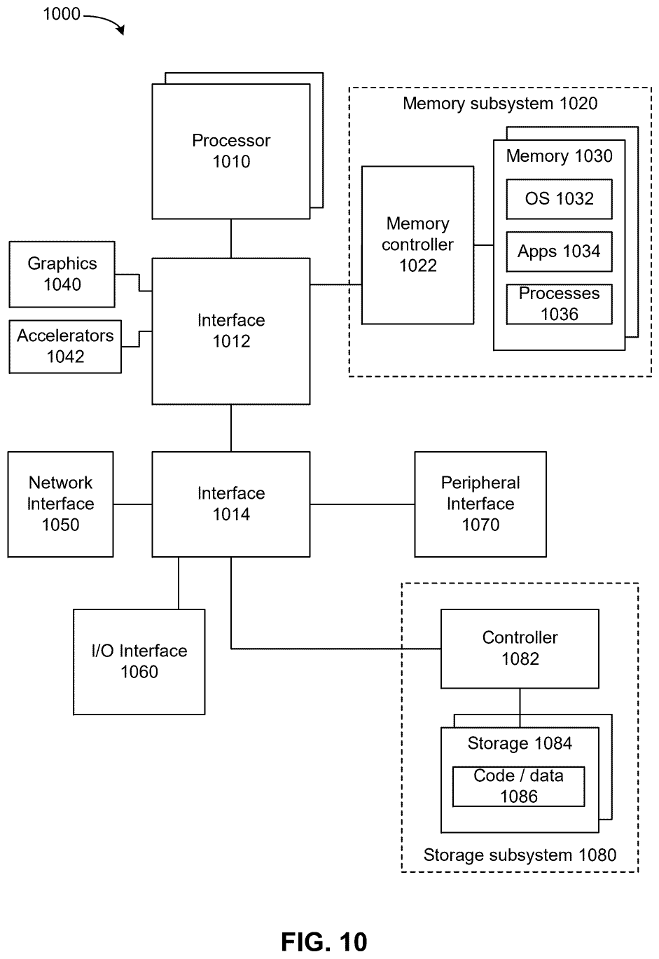

FIG. 10 depicts a system. In some examples, circuitry of system 1000 can apply debug policies, as described herein. System 1000 includes processor 1010, which provides processing, operation management, and execution of instructions for system 1000. Processor 1010 can include any type of microprocessor, central processing unit (CPU), graphics processing unit (GPU), XPU, processing core, or other processing hardware to provide processing for system 1000, or a combination of processors. An XPU can include one or more of: a CPU, a graphics processing unit (GPU), general purpose GPU (GPGPU), and/or other processing units (e.g., accelerators or programmable or fixed function field programmable gate arrays (FPGAs)). Processor 1010 controls the overall operation of system 1000, and can be or include, one or more programmable general-purpose or special-purpose microprocessors, digital signal processors (DSPs), programmable controllers, application specific integrated circuits (ASICs), programmable logic devices (PLDs), or the like, or a combination of such devices.

In one example, system 1000 includes interface 1012 coupled to processor 1010, which can represent a higher speed interface or a high throughput interface for system components that needs higher bandwidth connections, such as memory subsystem 1020 or graphics interface components 1040, or accelerators 1042. Interface 1012 represents an interface circuit, which can be a standalone component or integrated onto a processor die. Graphics interface 1040 can provide an interface to graphics components for providing a visual display to a user of system 1000. In one example, graphics interface 1040 can drive a display that provides an output to a user. In one example, the display can include a touchscreen display. In one example, graphics interface 1040 generates a display based on data stored in memory 1030 or based on operations executed by processor 1010 or both. In one example, graphics interface 1040 generates a display based on data stored in memory 1030 or based on operations executed by processor 1010 or both.

Accelerators 1042 can be a programmable or fixed function offload engine that can be accessed or used by a processor 1010. For example, an accelerator among accelerators 1042 can provide data compression (DC) capability, cryptography services such as public key encryption (PKE), cipher, hash/authentication capabilities, decryption, or other capabilities or services. In some cases, accelerators 1042 can be integrated into a CPU socket (e.g., a connector to a motherboard or circuit board that includes a CPU and provides an electrical interface with the CPU). For example, accelerators 1042 can include a single or multi-core processor, graphics processing unit, logical execution unit single or multi-level cache, functional units usable to independently execute programs or threads, application specific integrated circuits (ASICs), neural network processors (NNPs), programmable control logic, and programmable processing elements such as field programmable gate arrays (FPGAs). Accelerators 1042 can provide multiple neural networks, CPUs, processor cores, general purpose graphics processing units, or graphics processing units can be made available for use by artificial intelligence (AI) or machine learning (ML) models. For example, the AI model can use or include any or a combination of: a reinforcement learning scheme, Q-learning scheme, deep-Q learning, or Asynchronous Advantage Actor-Critic (A3C), combinatorial neural network, recurrent combinatorial neural network, or other AI or ML model. Multiple neural networks, processor cores, or graphics processing units can be made available for use by AI or ML models to perform learning and/or inference operations.

Memory subsystem 1020 represents the main memory of system 1000 and provides storage for code to be executed by processor 1010, or data values to be used in executing a routine. Memory subsystem 1020 can include one or more memory devices 1030 such as read-only memory (ROM), flash memory, one or more varieties of random access memory (RAM) such as DRAM, or other memory devices, or a combination of such devices. Memory 1030 stores and hosts, among other things, operating system (OS) 1032 to provide a software platform for execution of instructions in system 1000. Additionally, applications 1034 can execute on the software platform of OS 1032 from memory 1030. Applications 1034 represent programs that have their own operational logic to perform execution of one or more functions. Processes 1036 represent agents or routines that provide auxiliary functions to OS 1032 or one or more applications 1034 or a combination. OS 1032, applications 1034, and processes 1036 provide software logic to provide functions for system 1000. In one example, memory subsystem 1020 includes memory controller 1022, which is a memory controller to generate and issue commands to memory 1030. It will be understood that memory controller 1022 could be a physical part of processor 1010 or a physical part of interface 1012. For example, memory controller 1022 can be an integrated memory controller, integrated onto a circuit with processor 1010.

Applications 1034 and/or processes 1036 can refer instead or additionally to a virtual machine (VM), container, microservice, processor, or other software. Various examples described herein can perform an application composed of microservices, where a microservice runs in its own process and communicates using protocols (e.g., application program interface (API), a Hypertext Transfer Protocol (HTTP) resource API, message service, remote procedure calls (RPC), or Google RPC (gRPC)). Microservices can communicate with one another using a service mesh and be executed in one or more data centers or edge networks. Microservices can be independently deployed using centralized management of these services. The management system may be written in different programming languages and use different data storage technologies. A microservice can be characterized by one or more of: polyglot programming (e.g., code written in multiple languages to capture additional functionality and efficiency not available in a single language), or lightweight container or virtual machine deployment, and decentralized continuous microservice delivery.

In some examples, OS 1032 can be Linux®, Windows® Server or personal computer, FreeBSD®, Android®, MacOS®, iOS®, VMware vSphere, openSUSE, RHEL, CentOS, Debian, Ubuntu, or any other operating system. The OS and driver can execute on a processor sold or designed by Intel®, ARM®, Advanced Micro Devices, Inc. (AMD)®, Qualcomm®, IBM®, Nvidia®, Broadcom®, Texas Instruments®, or compatible with reduced instruction set computer (RISC) instruction set architecture (ISA) (e.g., RISC-V), among others.

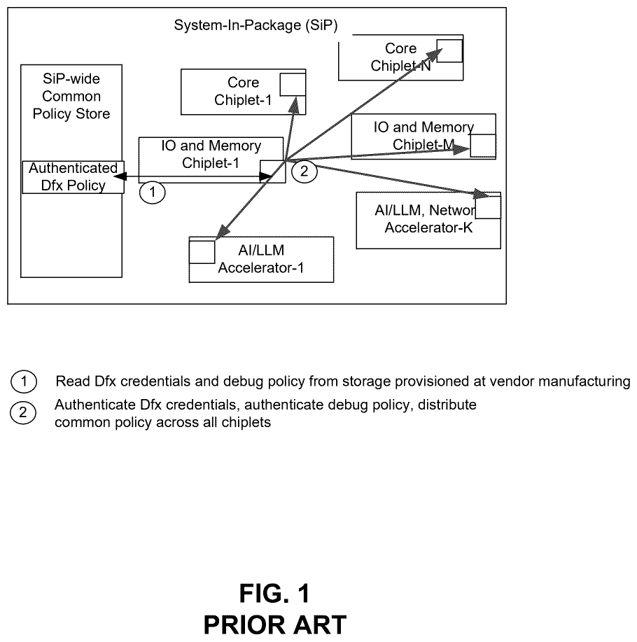

In some examples, OS 1032, a system administrator, and/or orchestrator can configure network interface 1050 to perform operations described at least with respect to FIG. 1 or 9.

While not specifically illustrated, it will be understood that system 1000 can include one or more buses or bus systems between devices, such as a memory bus, a graphics bus, interface buses, or others. Buses or other signal lines can communicatively or electrically couple components together, or both communicatively and electrically couple the components. Buses can include physical communication lines, point-to-point connections, bridges, adapters, controllers, or other circuitry or a combination. Buses can include, for example, one or more of a system bus, a Peripheral Component Interconnect express (PCIe) bus, a Hyper Transport or industry standard architecture (ISA) bus, a small computer system interface (SCSI) bus, a universal serial bus (USB), or an Institute of Electrical and Electronics Engineers (IEEE) standard 1394 bus (Firewire).

In one example, system 1000 includes interface 1014, which can be coupled to interface 1012. In one example, interface 1014 represents an interface circuit, which can include standalone components and integrated circuitry. In one example, multiple user interface components or peripheral components, or both, couple to interface 1014. Network interface 1050 provides system 1000 the ability to communicate with remote devices (e.g., servers or other computing devices) over one or more networks. Network interface 1050 can include an Ethernet adapter, wireless interconnection components, cellular network interconnection components, USB (universal serial bus), or other wired or wireless standards-based or proprietary interfaces. Network interface 1050 can transmit data to a device that is in the same data center or rack or a remote device, which can include sending data stored in memory. Network interface 1050 can receive data from a remote device, which can include storing received data into memory. In some examples, packet processing device or network interface device 1050 can refer to one or more of: a network interface controller (NIC), a remote direct memory access (RDMA)-enabled NIC, SmartNIC, router, switch, forwarding element, infrastructure processing unit (IPU), or data processing unit (DPU).

In one example, system 1000 includes one or more input/output (I/O) interface(s) 1060. I/O interface 1060 can include one or more interface components through which a user interacts with system 1000. Peripheral interface 1070 can include any hardware interface not specifically mentioned above. Peripherals refer generally to devices that connect dependently to system 1000.

In one example, system 1000 includes storage subsystem 1080 to store data in a nonvolatile manner. In one example, in certain system implementations, at least certain components of storage 1080 can overlap with components of memory subsystem 1020. Storage subsystem 1080 includes storage device(s) 1084, which can be or include any conventional medium for storing large amounts of data in a nonvolatile manner, such as one or more magnetic, solid state, or optical based disks, or a combination. Storage 1084 holds code or instructions and data 1086 in a persistent state (e.g., the value is retained despite interruption of power to system 1000). Storage 1084 can be generically considered to be a “memory,” although memory 1030 is typically the executing or operating memory to provide instructions to processor 1010. Whereas storage 1084 is nonvolatile, memory 1030 can include volatile memory (e.g., the value or state of the data is indeterminate if power is interrupted to system 1000). In one example, storage subsystem 1080 includes controller 1082 to interface with storage 1084. In one example controller 1082 is a physical part of interface 1014 or processor 1010 or can include circuits or logic in both processor 1010 and interface 1014.

A volatile memory is memory whose state (and therefore the data stored in it) is indeterminate if power is interrupted to the device. A non-volatile memory (NVM) device is a memory whose state is determinate even if power is interrupted to the device.

In an example, system 1000 can be implemented using interconnected compute sleds of processors, memories, storages, network interfaces, and other components. High speed interconnects can be used such as: Ethernet (IEEE 802.3), remote direct memory access (RDMA), InfiniBand, Internet Wide Area RDMA Protocol (iWARP), Transmission Control Protocol (TCP), User Datagram Protocol (UDP), quick UDP Internet Connections (QUIC), RDMA over Converged Ethernet (RoCE), Peripheral Component Interconnect express (PCIe), Intel QuickPath Interconnect (QPI), Intel Ultra Path Interconnect (UPI), Intel On-Chip System Fabric (IOSF), Omni-Path, Compute Express Link (CXL), HyperTransport, high-speed fabric, NVLink, Advanced Microcontroller Bus Architecture (AMBA) interconnect, OpenCAPI, Gen-Z, Infinity Fabric (IF), Cache Coherent Interconnect for Accelerators (CCIX), 3GPP Long Term Evolution (LTE) (4G), 3GPP 5G, and variations thereof. Data can be copied or stored to virtualized storage nodes or accessed using a protocol such as NVMe over Fabrics (NVMe-oF) or NVMe (e.g., a non-volatile memory express (NVMe) device can operate in a manner consistent with the Non-Volatile Memory Express (NVMe) Specification, revision 1.3c, published on May 24, 2018 (“NVMe specification”) or derivatives or variations thereof).

Communications between devices can take place using a network that provides die-to-die communications; chip-to-chip communications; circuit board-to-circuit board communications; and/or package-to-package communications.

In an example, system 1000 can be implemented using interconnected compute sleds of processors, memories, storages, network interfaces, and other components. High speed interconnects can be used such as PCIe, Ethernet, or optical interconnects (or a combination thereof).

Examples herein may be implemented in various types of computing and networking equipment, such as switches, routers, racks, and blade servers such as those employed in a data center and/or server farm environment. The servers used in data centers and server farms comprise arrayed server configurations such as rack-based servers or blade servers. These servers are interconnected in communication via various network provisions, such as partitioning sets of servers into Local Area Networks (LANs) with appropriate switching and routing facilities between the LANs to form a private Intranet. For example, cloud hosting facilities may typically employ large data centers with a multitude of servers. A blade comprises a separate computing platform that is configured to perform server-type functions, that is, a “server on a card.” Accordingly, a blade includes components common to conventional servers, including a main printed circuit board (main board) providing internal wiring (e.g., buses) for coupling appropriate integrated circuits (ICs) and other components mounted to the board.

Various examples may be implemented using hardware elements, software elements, or a combination of both. In some examples, hardware elements may include devices, components, processors, microprocessors, circuits, circuit elements (e.g., transistors, resistors, capacitors, inductors, and so forth), integrated circuits, ASICs, PLDs, DSPs, FPGAs, memory units, logic gates, registers, semiconductor device, chips, microchips, chip sets, and so forth. In some examples, software elements may include software components, programs, applications, computer programs, application programs, system programs, machine programs, operating system software, middleware, firmware, software modules, routines, subroutines, functions, methods, procedures, software interfaces, APIs, instruction sets, computing code, computer code, code segments, computer code segments, words, values, symbols, or any combination thereof. Determining whether an example is implemented using hardware elements and/or software elements may vary in accordance with any number of factors, such as desired computational rate, power levels, heat tolerances, processing cycle budget, input data rates, output data rates, memory resources, data bus speeds and other design or performance constraints, as desired for a given implementation. A processor can be one or more combination of a hardware state machine, digital control logic, central processing unit, or any hardware, firmware and/or software elements.

Some examples may be implemented using or as an article of manufacture or at least one computer-readable medium. A computer-readable medium may include a non-transitory storage medium to store logic. In some examples, the non-transitory storage medium may include one or more types of computer-readable storage media capable of storing electronic data, including volatile memory or non-volatile memory, removable or non-removable memory, erasable or non-erasable memory, writeable or re-writeable memory, and so forth. In some examples, the logic may include various software elements, such as software components, programs, applications, computer programs, application programs, system programs, machine programs, operating system software, middleware, firmware, software modules, routines, subroutines, functions, methods, procedures, software interfaces, API, instruction sets, computing code, computer code, code segments, computer code segments, words, values, symbols, or any combination thereof.

According to some examples, a computer-readable medium may include a non-transitory storage medium to store or maintain instructions that when executed by a machine, computing device or system, cause the machine, computing device or system to perform methods and/or operations in accordance with the described examples. The instructions may include any suitable type of code, such as source code, compiled code, interpreted code, executable code, static code, dynamic code, and the like. The instructions may be implemented according to a predefined computer language, manner or syntax, for instructing a machine, computing device or system to perform a certain function. The instructions may be implemented using any suitable high-level, low-level, object-oriented, visual, compiled and/or interpreted programming language.

One or more aspects of at least one example may be implemented by representative instructions stored on at least one machine-readable medium which represents various logic within the processor, which when read by a machine, computing device or system causes the machine, computing device or system to fabricate logic to perform the techniques described herein. Such representations, known as “IP cores” may be stored on a tangible, machine readable medium and supplied to various customers or manufacturing facilities to load into the fabrication machines that actually make the logic or processor.

The appearances of the phrase “one example” or “an example” are not necessarily all referring to the same example or embodiment. Any aspect described herein can be combined with any other aspect or similar aspect described herein, regardless of whether the aspects are described with respect to the same figure or element. Division, omission, or inclusion of block functions depicted in the accompanying figures does not infer that the hardware components, circuits, software and/or elements for implementing these functions would necessarily be divided, omitted, or included in embodiments.

Some examples may be described using the expression “coupled” and “connected” along with their derivatives. For example, descriptions using the terms “connected” and/or “coupled” may indicate that two or more elements are in direct physical or electrical contact. The term “coupled,” however, may also mean that two or more elements are not in direct contact, but yet still co-operate or interact.

The terms “first,” “second,” and the like, herein do not denote any order, quantity, or importance, but rather are used to distinguish one element from another. The terms “a” and “an” herein do not denote a limitation of quantity, but rather denote the presence of at least one of the referenced items. The term “asserted” used herein with reference to a signal denote a state of the signal, in which the signal is active, and which can be achieved by applying any logic level either logic 0 or logic 1 to the signal. The terms “follow” or “after” can refer to immediately following or following after some other event or events. Other sequences of operations may also be performed according to alternative embodiments. Furthermore, additional operations may be added or removed depending on the particular applications. Any combination of changes can be used and one of ordinary skill in the art with the benefit of this disclosure would understand the many variations, modifications, and alternative embodiments thereof.

Disjunctive language such as the phrase “at least one of X, Y, or Z,” unless specifically stated otherwise, is otherwise understood within the context as used in general to present that an item, term, etc., may be either X, Y, or Z, or any combination thereof (e.g., X, Y, and/or Z). Thus, such disjunctive language is not generally intended to, and should not, imply that certain embodiments require at least one of X, at least one of Y, or at least one of Z to be present. Additionally, conjunctive language such as the phrase “at least one of X, Y, and Z,” unless specifically stated otherwise, should also be understood to mean X, Y, Z, or any combination thereof, including “X, Y, and/or Z.”

Illustrative examples of the devices, systems, and methods disclosed herein are provided below. An embodiment of the devices, systems, and methods may include any one or more, and any combination of, the examples described below.

Example 1 includes one or more examples, and includes an apparatus that includes: a chiplet comprising a circuitry to store a security policy, wherein the security policy is specific to the chiplet and a second chiplet comprising a second circuitry to store a second security policy, wherein the second security policy is specific to the second chiplet.

Example 2 includes one or more examples, wherein: the security policy comprises a debug policy, the circuitry is to determine a debug policy for multiple chiplets to apply, and at least two of the multiple chiplets are from different chiplet manufacturers.

Example 3 includes one or more examples, wherein: during a debug operation, the multiple chiplets are to share security assets with a debugger based on the determined debug policy.

Example 4 includes one or more examples, wherein the debug operation is to collect hardware secrets, hardware keys, hash of a key, performance data, or execution traces of the multiple chiplets.

Example 5 includes one or more examples, wherein the determine the debug policy for the multiple chiplets to apply comprises select a highest common debug policy of different debug policies of different chiplets.

Example 6 includes one or more examples, wherein: the debug policy is selected from two or more policies, a first of the two or more policies is to not permit sharing of security assets, a second of the two or more policies is to permit sharing of security assets in response to sharing of a first key, and a third of the two or more policies is to permit sharing of security assets in response to sharing of a second key.

Example 7 includes one or more examples, wherein the security assets comprise one or more of: a device key, event log, execution trace, or event sequence.

Example 8 includes one or more examples, comprising a system-in-package (SiP) that comprises the chiplet and chiplets from different manufacturers.

Example 9 includes one or more examples, and includes a method comprising: configuring multiple chiplets with security policies specific to the respective multiple chiplets.

Example 10 includes one or more examples, wherein: a security policy of the security policies comprises a debug policy and a debug policy negotiation key.

Example 11 includes one or more examples, comprising: determining, by a chiplet of the chiplets, a debug policy to apply for chiplets from different vendors and based on authentication of a debug request, providing secure data to a debugger.

Example 12 includes one or more examples, comprising: during a debug operation, sharing, by multiple chiplets, security assets with the debugger based on the determined debug policy, wherein: at least two of the respective chiplets are from different chiplet manufacturers.

Example 13 includes one or more examples, wherein: the determining the debug policy to apply for the chiplets comprises synchronizing different debug policies of different chiplets and selecting a highest common debug policy.

Example 14 includes one or more examples, wherein the security assets comprise one or more of: a device key, event log, execution trace, or event sequence.

Example 15 includes one or more examples, and includes at least one computer-readable medium comprising instructions stored thereon, that when executed by one or more circuitry, cause the one or more circuitry to: configure a chiplet with a security policy specific to the chiplet and configure the chiplet to determine a debug policy for multiple chiplets to apply, wherein the multiple chiplets are from different vendors.

Example 16 includes one or more examples, wherein: the security policy specific to the chiplet comprises a debug policy and a debug policy negotiation key.

Example 17 includes one or more examples, comprising instructions stored thereon, that if executed by one or more circuitry, cause the one or more circuitry to: configure the chiplet to: based on authentication of a debug request, provide secure data to a debugger.

Example 18 includes one or more examples, wherein the secure data comprises one or more of: a device key, event log, execution trace, or event sequence.

Example 19 includes one or more examples, comprising instructions stored thereon, that if executed by one or more circuitry, cause the one or more circuitry to: during a debug operation, sharing, by the multiple chiplets, security assets with a debugger based on the determined security policy, wherein: at least two of the multiple chiplets are from different chiplet manufacturers.

Example 20 includes one or more examples, wherein the determine the debug policy for the multiple chiplets to apply comprises synchronizing different debug policies of different chiplets and selecting a highest common debug policy.

1. An apparatus comprising:
a chiplet comprising a circuitry to store a security policy, wherein the security policy is specific to the chiplet and
a second chiplet comprising a second circuitry to store a second security policy, wherein the second security policy is specific to the second chiplet.

2. The apparatus of claim 1, wherein:
the security policy comprises a debug policy,
the circuitry is to determine a debug policy for multiple chiplets to apply, and
at least two of the multiple chiplets are from different chiplet manufacturers.

3. The apparatus of claim 2, wherein:
during a debug operation, the multiple chiplets are to share security assets with a debugger based on the determined debug policy.

4. The apparatus of claim 3, wherein the debug operation is to collect hardware secrets, hardware keys, hash of a key, performance data, or execution traces of the multiple chiplets.

5. The apparatus of claim 2, wherein the determine the debug policy for the multiple chiplets to apply comprises select a highest common debug policy of different debug policies of different chiplets.

6. The apparatus of claim 2, wherein:
the debug policy is selected from two or more policies,
a first of the two or more policies is to not permit sharing of security assets,
a second of the two or more policies is to permit sharing of security assets in response to sharing of a first key, and
a third of the two or more policies is to permit sharing of security assets in response to sharing of a second key.

7. The apparatus of claim 6, wherein the security assets comprise one or more of: a device key, event log, execution trace, or event sequence.

8. The apparatus of claim 1, comprising a system-in-package (SiP) that comprises the chiplet and chiplets from different manufacturers.

9. A method comprising:
configuring multiple chiplets with security policies specific to the respective multiple chiplets.

10. The method of claim 9, wherein:
a security policy of the security policies comprises a debug policy and a debug policy negotiation key.

11. The method of claim 9, comprising:
determining, by a chiplet of the chiplets, a debug policy to apply for chiplets from different vendors and
based on authentication of a debug request, providing secure data to a debugger.

12. The method of claim 11, comprising:
during a debug operation, sharing, by multiple chiplets, security assets with the debugger based on the determined debug policy, wherein: at least two of the respective chiplets are from different chiplet manufacturers.

13. The method of claim 11, wherein:
the determining the debug policy to apply for the chiplets comprises synchronizing different debug policies of different chiplets and selecting a highest common debug policy.

14. The method of claim 12, wherein the security assets comprise one or more of: a device key, event log, execution trace, or event sequence.

15. At least one computer-readable medium comprising instructions stored thereon, that when executed by one or more circuitry, cause the one or more circuitry to:
configure a chiplet with a security policy specific to the chiplet and
configure the chiplet to determine a debug policy for multiple chiplets to apply, wherein the multiple chiplets are from different vendors.

16. The computer-readable medium of claim 15, wherein:
the security policy specific to the chiplet comprises a debug policy and a debug policy negotiation key.

17. The computer-readable medium of claim 15, comprising instructions stored thereon, that if executed by one or more circuitry, cause the one or more circuitry to:
configure the chiplet to:
based on authentication of a debug request, provide secure data to a debugger.

18. The computer-readable medium of claim 17, wherein the secure data comprises one or more of: a device key, event log, execution trace, or event sequence.

19. The computer-readable medium of claim 15, comprising instructions stored thereon, that if executed by one or more circuitry, cause the one or more circuitry to:
during a debug operation, sharing, by the multiple chiplets, security assets with a debugger based on the determined security policy, wherein: at least two of the multiple chiplets are from different chiplet manufacturers.

20. The computer-readable medium of claim 15, wherein the determine the debug policy for the multiple chiplets to apply comprises synchronizing different debug policies of different chiplets and selecting a highest common debug policy.
